(19) United States
(12) Patent Application Publication
(10) Pub. No.: US 2008/0242528 A1
(43) Pub. Date: Oct. 2, 2008

(54) OPTICAL GLASS AND METHOD OF PRODUCING THE SAME

(76) Inventor: Motoaki Saito, Saitama-shi (JP)

Correspondence Address: BIRCH STEWART KOLASCH & BIRCH, PO BOX 747, FALLS CHURCH, VA, 22040-0747, US

(21) Appl. No.: 12/054,090

(22) Filed: Mar. 24, 2008

(30) Foreign Application Priority Data
Mar. 30, 2007 (JP) P2007-094140

(51) Int. Cl. C03C 3/253

(52) U.S. Cl. 501/42

(57) ABSTRACT

An optical glass comprises:
germanium oxide (GeO₂) content of 14 wt % to 21 wt %;
niobium oxide (Nb₂O₅) content of 14 wt % to 23 wt %;
bismuth oxide (Bi₂O₃) content of 40 wt % to 52 wt %;
tungsten oxide (WO₃) content of 0 wt % to 5 wt %;
phosphoric acid (P₂O₅) content of 7 wt % to 14 wt %;
potassium oxide (K₂O) content of 0 wt % to 4 wt %;
barium oxide (BaO) content of 0 wt % to 5 wt %;
lithium oxide (Li₂O) content of 0 wt % to 3 wt %;
sodium oxide (Na₂O) content of 0 wt % to 2 wt %; and
titanium oxide (TiO₂) content of 1 wt % to 5 wt %,
wherein iron (Fe) content is less than 10 ppm based on the total weight of the titanium oxide.

### BACKGROUND OF THE INVENTION

1. Field of the Invention

The present invention relates to an optical glass suitable for a high-precision press molding at a relatively low temperature and a method of producing the optical glass.

2. Description of the Related Art

Recently, there has been rapidly spread a digital camera or a cellular phone attached with a camera for inputting image information by an image pickup element such as a charge coupled device (CCD) or a complementary metal oxide semiconductor (CMOS). Recently, in order to realize a high-quality image, an image pickup device with the large number of pixels has been developed, and therefore an image pickup lens with a high optical capability has been demanded. Simultaneously, a decrease in the size thereof has also been demanded.

In order to meet such demand, a molded lens of glass made by a press molding with a mold of a high precision size is largely used as the image pickup lens. Such a pressing molding makes it possible to produce an optical lens with an aspheric surface or an optical lens of a minute size more easily and more effective than a grinding molding.

However, such a press molding is performed at a high temperature equal to or more than a breakdown temperature of an optical glass which become a material. Consequently, a mold which receives considerably physical load such as heat or stress is required to have high durability. Of course, as the breakdown temperature of the optical glass increases, the physical load applied on the mold increases. Consequently, in order to improve the lifetime of the mold, it is required that the breakdown temperature of the optical glass be low as much as possible.

On the other hand, in order to reduce the size of the image pickup lens or in order to realize a wide viewing angle, a high refractive index of the optical glass has also been demanded.

In such circumstances, various types of optical glass having a high refractive index and a relatively low breakdown temperature (and a glass transition temperature) have been developed (for example, see JP-A-2003-300751 and JP-A-2003-335549).

According to an optical glass disclosed in JP-A-2003-300751, a refractive index for the d-line (587.6 nm) of 1.90 or more and a glass transition temperature of 523° C. (breakdown temperature of 569° c.) are realized (for example, see Example 10 of Table 2). Moreover, JP-A-2003-335549 discloses an optical glass having the refractive index of 1.83 or more for the d-line and the glass transition temperature 490° C. (breakdown temperature of 540° C.) (see Example 9 of Table 2). However, a decrease in the size of the image pickup lens and a high performance have recently been noticeable, and thus a higher refractive index of the optical glass and an easier processing operation have been further demanded.

### SUMMARY OF THE INVENTION

The invention is made in view of such problems, and an object of the invention is to provide an optical glass which has higher refractive index and is excellent in a molding property. Moreover, another object of the invention is to provide a method of producing the optical glass.

According to an aspect of the invention, there is provided an optical glass including: germanium oxide (GeO₂) content of 14 wt % to 21 wt %; niobium oxide (Nb₂O₅) content of 14 wt % to 23 wt %; bismuth oxide (Bi₂O₃) content of 40 wt % to 52 wt %; tungsten oxide (WO₃) content of 0 wt % to 5 wt %; phosphoric acid (P₂O₅) content of 7 wt % to 14 wt %; potassium oxide (K₂O) content of 0 wt % to 4 wt %; barium oxide (BaO) content of 0 wt % to 5 wt %; lithium oxide (Li₂O) content of 0 wt % to 3 wt %; sodium oxide (Na₂O) content of 0 wt % to 2 wt %; and titanium oxide (TiO₂) content of 1 wt % to 5 wt %. In this case, the iron content is less than 10 ppm based on the total weight of TiO₂. Moreover, the content range of WO₃, K₂O, BaO, Li₂O, and Na₂O also contains 0 wt %. That is, these are an arbitrary component.

Since the optical glass has the above-described proportion ratio, the high refractive index is guaranteed and a performance suitable for the press molding is exerted. Specifically, the refractive index is improved by containing a predetermined amount of Bi₂O₃, GeO₂, TiO₂, and WO₃. Moreover, the breakdown temperature decreases by containing a predetermined amount of Bi₂O₃, Li₂O, Na₂O, K₂O, and BaO. Furthermore, coloring (for example, deterioration of transmissivity for a short wavelength) is sufficiently reduced by containing a small amount of content of iron, which is an impurity. Still furthermore, devitrification resistance is improved in performing a processing operation by containing P₂O₅, Bi₂O₃, Nb₂O₅, TiO₂, WO₃, Li₂O, Na₂O, BaO, etc. in good balance.

According to another aspect of the invention, there is provided a method of producing an optical glass including the steps of: melting a raw mixture that GeO₂, Nb₂O₅, Bi₂O₃, WO₃, K₂O, BaO, Li₂O, Na₂O, and TiP₂O₇ by a heating operation; and forming the optical glass that contains GeO₂ content of 14 wt % to 21 wt %, Nb₂O₅ content of 14 wt % to 23 wt %, Bi₂O₃ content of 40 wt % to 52 wt %, WO₃ content of 0 wt % to 5 wt %, P₂O₅ content of 7 wt % to 14 wt %, K₂O content of 0 wt % to 4 wt %, BaO content of 0 wt % to 5 wt %, Li₂O content of 0 wt % to 3 wt %, Na₂O content of 0 wt % to 2 wt %, and TiO₂ content of 1 wt % to 5 wt % by cooling the molten raw mixture to a glass transition temperature or less. In such a method, TiP₂O₇ in which iron content is less than 10 ppm based on the total weight of the titanium pyrophosphate is used.

In the method of producing the optical glass according to the invention, the raw mixture having the above-described proportion ratio is used. As a result, the optical glass which has a high refractive index, a low breakdown temperature, and excellent devitrification resistance can be produced. Moreover, coloring can be sufficiently reduced by using TiP₂O₇ in which iron content is less than 10 ppm based on the total weight.

### BRIEF DESCRIPTION OF THE DRAWINGS

FIG. 1 is a diagram for explaining respective components and contents of an optical glass according to Examples of the invention (Examples 1 and 2); and

FIG. 2 is a diagram for explaining respective components and contents of an optical glass according to Comparative Examples of the invention (Comparative Examples 1 to 4).

### DETAILED DESCRIPTION OF THE INVENTION

Hereinafter, an embodiment of the invention will be described in detail.

An optical glass according to the invention is suitable for an image pickup lens mounted in, for example, a digital still camera, a silver-salt camera, or a module camera for a cellular phone.

The optical glass contains germanium oxide (GeO₂), niobium oxide (Nb₂O₅), bismuth oxide (Bi₂O₃), tungsten oxide (WO₃), phosphoric acid (P₂O₅), potassium oxide (K₂O), barium oxide (BaO), lithium oxide (Li₂O), sodium oxide (Na₂O), and titanium oxide (TiO₂) as components.

The respective contents of the components are as follows. In addition, “%” in the following description all refers to “wt %”. First, the GeO₂ content is in the range from 14% to 21%, the Nb₂O₅ content is in the range from 14% to 23%, the Bi₂O₃ content is in the range from 40% to 52%, the WO₃ content is in the range from 0% to 5%, the P₂O₅ content is in the range from 7% to 14%, the K₂O content of is in the range from 0% to 4%, the BaO content is in the range from 0% to 5%, the Li₂O content is in the range from 0% to 3%, the Na₂O content of is in the range from 0% to 2%, and the TiO₂ content is in the range from 1% to 5%.

P₂O₅ is an essential component of the optical glass. The P₂O₅ content of 7% or more suppresses deterioration of a molding property and facilitates formation of glass. On the other hand, the P₂O₅ content of 14% or less improves a stability of the glass in terms of a structure. In addition, P₂O₅ has a property of lowering a breakdown temperature (and a glass transition temperature) of the optical glass.

GeO₂ is an effective component for improving a refractive index of the optical glass. By containing the GeO₂ content of 14% to 21%, a high refractive index is guaranteed and good devitrification resistance can also be obtained (it is easy to avoid devitrification generated by a processing operation such as a press molding).

Bi₂O₃ is an effective component for improving the refractive index of the optical glass and also lowering the breakdown temperature (and the glass transition temperature). By containing the Bi₂O₃ content of 40% to 52% based on the total weight, a high refractive index and a low breakdown temperature (and the glass transition temperature) can be compatible and the good devitrification resistance can also be obtained.

Nb₂O₅ is an effective component for obtaining the high refractive index, and coexistence with Bi₂O₃ improves the devitrification resistance in the processing operation. By containing the Nb₂O₅ contents of 14% to 23% based on the total weight, it is possible to sufficiently obtain such an advantage. Moreover, the existence of Nb₂O₅ makes it possible to obtain high dispersion.

WO₃, which is an arbitrary component, is an effective component for obtaining the high refractive index similarly to Nb₂O₅, and coexistence with Bi₂O₃ improves the devitrification resistance in the press molding. By containing the WO₃ content of 5% or less based on the total weight, it is possible to sufficiently obtain such an advantage. Moreover, the existence of WO₃ makes it possible to obtain the high dispersion.

K₂O can lower the breakdown temperature (and the glass transition temperature) and has a property of improving the stability of glass in terms of the structure. In addition, K₂O is an arbitrary component which can be added, if necessary. When the K₂O content is 4% or less based on the total weight, it is possible to obtain the good devitrification resistance and chemical durability (water resistance, acid resistance, etc.).

BaO, which is an arbitrary component, is appropriately added in order to obtain solubility and the stability in terms of the structure. The BaO content of 5% or less based on the total weight easily guarantees a low breakdown temperature (and the glass transition temperature).

Li₂O is also an arbitrary component. Furthermore, since such an alkali metal component decomposes bond of phosphorus (P) and oxygen (O) of P₂O₅, the component is effective in lowering the breakdown temperature (and the glass transition temperature) of the optical glass. The Li₂O content of 3% or less guarantees the good devitrification resistance and the chemical durability.

Na₂O is also an arbitrary component which can gain the same advantage as that of Li₂O. The Na₂O content of 2% or less based on the total weight guarantees the good devitrification resistance and the chemical durability.

TiO₂ is an effective component for guaranteeing the high refractive index in the optical glass. In addition, coexistence with Bi₂O₃ can improve the devitrification resistance in the processing operation. By containing the TiO₂ content of 1 to 5% based on the total weight, it is possible to gain such advantages. Moreover, existence of TiO₂ makes it possible to obtain the high dispersion.

The optical glass has iron as an impurity of less than 10 ppm based on the total weight of TiO₂. For this reason, deterioration of transmissivity for a short wavelength can be suppressed, thereby obtaining a good transmissivity distribution.

The optical glass can be produced as the following exemplary method. First, the respective raw powders of GeO₂, Nb₂O₅, Bi₂O₃, WO₃, K₂O, BaO, Li₂O, Na₂O, and TiP₂O₇ are mixed at a predetermined proportion to obtain a raw mixture. Here, the raw powder of TiP₂O₇ in which the iron content is less than 10 ppm based on the total weight is used. Next, a predetermined amount of raw mixture is put in a crucible heated at a predetermined temperature and is sequentially molten while maintaining the temperature of the crucible (a melting process). Subsequently, while maintaining the temperature of the crucible, the molten raw mixture is stirred for a predetermined period of time (a stirring process), and then bubbles are removed after leaving the stirred raw mixture for a predetermined period of time (a fining process). Finally, a raw mixture is made to flow out from the crucible while stirring the raw mixture and maintaining the temperature of the crucible, and the metallic water is pore in a mold which has been heated at a predetermined temperature and is cooled to obtain the optical glass according the embodiment.

When a lens is formed using the optical glass, the following steps are performed. First, the optical glass is molten to form a pre-form having predetermined shape and size. Next, the pre-form is inserted into a mold processed in a desired form and with high precision to perform a press molding. After both temperatures of the mold and the pre-form is increased to nearly a softening point of the pre-form, pressure is applied, and then a temperature is lowered to the glass transition temperature while maintaining the pressure state. After the molded lens is taken out from the mold, predetermined processes such as an annealing process, if necessary, are performed to complete production of the lens.

In the optical glass according to the embodiment, predetermined amounts of the respective components are contained. Consequently, it is possible to guarantee the higher refractive index and reduce the breakdown temperature (and the glass transition temperature). For example, the refractive index for the d-line is set to 1.95 or more and the glass transition temperature can also be set to 500° C. or less. Next, even when the press molding is performed nearly at the glass transition temperature, the accompanying devitrification (so-called low temperature devitrification) can be avoided. Moreover, there is no generation of devitrification (so-called high temperature devitrification) when producing the optical glass. Since the iron content is less than 10 ppm based on the total weight of the TiO₂, problematic coloring can be practically avoided. Consequently, by using such an optical glass, it is possible to more effectively produce the molded lens having a good optical characteristic. Furthermore, since load related to the heat applied to the mold for using the press molding of the optical glass can be reduced, using the mold for a long time is possible.

### EXAMPLES

Next, specific Examples of an optical glass according to the invention will be described.

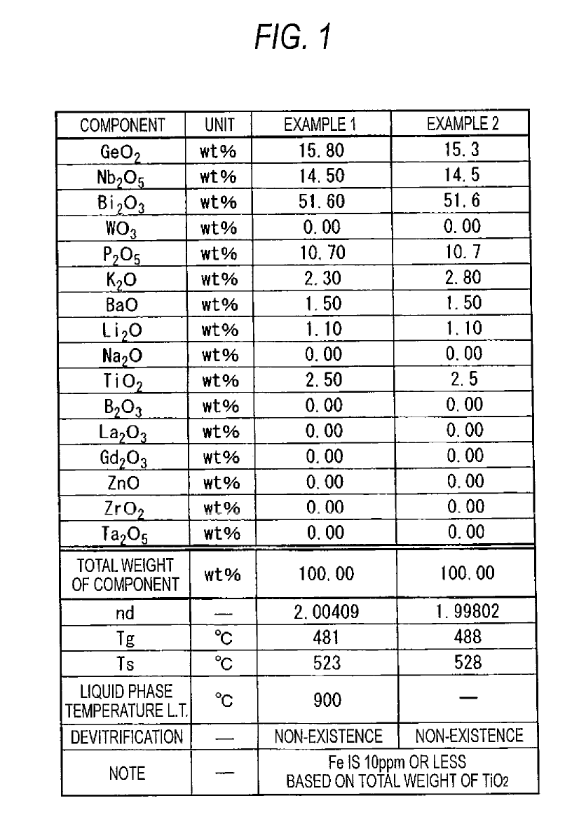

FIG. 1 shows the content (wt %) of the respective components contained in the optical glass according to Examples of the invention (Examples 1 and 2). In Examples 1 and 2, the GeO₂ content is in the range from 14% to 21%, the Nb₂O₅ content is in the range from 14% to 23%, the Bi₂O₃ content is in the range from 40% to 52%, the WO₃ content is in the range from 0% to 5%, the P₂O₅ content is in the range from 7% to 14%, the K₂O content is in the range from 0% to 4%, the BaO content is in the range from 0% to 5%, the Li₂O content is in the range from 0% to 3%, the Na₂O content is in the range from 0% to 2%; and the TiO₂ content is in the range from 1% to 5%.

FIG. 1 also shows various characteristic values of the optical glass according to Examples 1 and 2. Specifically, a refractive index nd for the d-line, a glass transition temperature Tg (° C.), a breakdown temperature Ts (° C.), and a liquid phase temperature L.T. (° C.) of the optical glass according to Examples 1 and 2 and existence or non-existence of devitrification at the breakdown temperature Ts are shown. A temperature of 1000° C. was maintained for 30 to 60 minutes when producing the optical glass according to Examples, and the annealing process was performed at 470° C. for 2 to 4 hours.

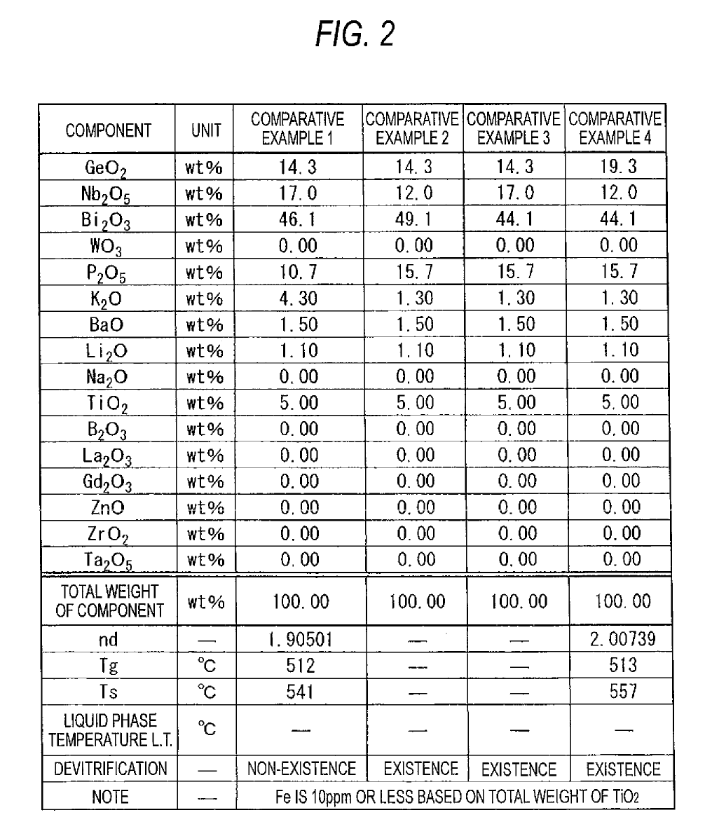

In Comparative Examples 1 to 4, optical glasses in which the content of at least one kind of K₂O, Nb₂O₅, and P₂O₅ is deviated from the predetermined content range were produced. Each component and each characteristic value in Comparative Examples 1 to 4 are shown in FIG. 2.

As known from respective value data shown in FIG. 1, the high refractive index nd of 1.99 can be guaranteed, and the lower glass transition temperature Tg (481° C. or 488° C.) and the lower breakdown temperature Ts (523° C. or 528° C.) are shown in Examples 1 and 2. In addition, in Examples 1 and 2, the devitrification was not generated even at the breakdown temperature Ts (523° C. or 528° C.). Moreover, the coloring was not shown in a short wavelength.

From the above-mentioned results, in the optical glass containing the components according to the embodiment, it was known that a balance between the refractive index nd and the breakdown temperature Ts (or the glass transition temperature Tg) is considerably good and the devitrification is rarely generated, thereby resulting in an excellent practical use. That is, it was confirmed that the optical glass according to Examples is suitable for a lens material which can be produced at a relatively low temperature by a high precision press molding and has a higher optical performance.

The invention has been described with reference to the embodiment and Examples. However, the invention is not limited to the embodiment and Examples, but may be modified in various forms. For example, the components of the optical glass are not limited to the above-mentioned values of the respective Examples, but may take other values.

According to the invention, an optical glass contains predetermined amounts of GeO₂, Nb₂O₅, Bi₂O₃, WO₃, P₂O₅, K₂O, BaO, Li₂O, Na₂O, and TiO₂. As a result, it is possible to improve a refractive index and also maintain that a breakdown temperature (and the glass transition temperature) is low. Moreover, it is possible to prevent devitrification in a pressing molding. Since such an optical glass can be formed at a relatively low temperature, the optical glass is suitable for producing a molded lens having a small size and a high optical performance. Furthermore, it is possible to sufficiently prevent coloring from being generated since the iron content is less than 10 ppm based on the total weight of TiO₂.

According to the invention, the method of producing the optical glass includes the steps of melting and cooling a raw mixture containing predetermined amounts of GeO₂, Nb₂O₅, Bi₂O₃, WO₃, K₂O, BaO, Li₂O, Na₂O, and TiP₂O. As a result, it is possible to realize an optical glass which has a higher refractive index and a lower breakdown temperature (and a glass transition temperature) and in which devitrification is rarely generated in a press molding. Moreover, it is possible to obtain the optical glass in which the coloring is sufficiently prevented by using TiP₂O₇ in which the iron content is less than 10 ppm based on the total weight.

The entire disclosure of each and every foreign patent application from which the benefit of foreign priority has been claimed in the present application is incorporated herein by reference, as if fully set forth.

What is claimed is:

1. An optical glass comprising:
germanium oxide (GeO₂) content of 14 wt % to 21 wt %;
niobium oxide (Nb₂O₅) content of 14 wt % to 23 wt %;
bismuth oxide (Bi₂O₃) content of 40 wt % to 52 wt %;
tungsten oxide (WO₃) content of 0 wt % to 5 wt %;
phosphoric acid (P₂O₅) content of 7 wt % to 14 wt %;
potassium oxide (K₂O) content of 0 wt % to 4 wt %;
barium oxide (BaO) content of 0 wt % to 5 wt %;
lithium oxide (Li₂O) content of 0 wt % to 3 wt %;
sodium oxide (Na₂O) content of 0 wt % to 2 wt %; and
titanium oxide (TiO₂) content of 1 wt % to 5 wt %,
wherein iron (Fe) content is less than 10 ppm based on the total weight of the titanium oxide.

2. The optical glass according to claim 1, which has a refractive index for the d-line (587.6 nm) of 1.95 or more and has a glass transition temperature of 500° C. or less.

3. A method of producing an optical glass comprising:
melting a raw mixture that comprises germanium oxide (GeO₂) niobium oxide (Nb₂O₅), bismuth oxide (Bi₂O₃), tungsten oxide (WO₃), potassium oxide (K₂O), barium oxide (BaO), lithium oxide (Li₂O), sodium oxide (Na₂O), and titanium pyrophosphate (TiP₂O₇) by a heating operation; and
forming the optical glass that comprises GeO₂ content of 14 wt % to 21 wt %, Nb₂O₅ content of 14 wt % to 23 wt %, Bi₂O₃ content of 40 wt % to 52 wt %, WO₃ content of 0 wt % to 5 wt %, P₂O₅ content of 7 wt % to 14 wt %, K₂O content of 0 wt % to 4 wt %, BaO content of 0 wt % to 5 wt %, Li₂O content of 0 wt % to 3 wt %, Na₂O content of 0 wt % to 2 wt %, and TiO₂ content of 1 wt % to 5 wt % by cooling the molten raw mixture to a glass transition temperature or less,
wherein the titanium pyrophosphate (TiP₂O₇) in which iron (Fe) content is less than 10 ppm based on the total weight of the titanium pyrophosphate is used.

4. The method according to claim 3,
wherein the titanium pyrophosphate (TiP₂O₇) is decomposed into titanium oxide (TiO₂) and phosphoric acid (P₂O₅) in the melting of the raw mixture.
